(19) United States
(12) Patent Application Publication
(10) Pub. No.: US 2022/0277295 A1
(43) Pub. Date: Sep. 1, 2022

(54) SYSTEMS AND METHODS FOR USE IN MANAGING COMPLEX USER CREDENTIALS

(71) Applicant: MASTERCARD INTERNATIONAL INCORPORATED, Purchase, NY (US)

(72) Inventors: Bryn Anthony Robinson-Morgan, Mosborough Village (GB); Charles Walton, Marshfield, MA (US); Liang Tian, Rye Brook, NY (US); Prashant Sharma, Madison, NJ (US)

(21) Appl. No.: 17/189,033

(22) Filed: Mar. 1, 2021

(51) Int. Cl. G06Q 20/36; G06Q 20/40; G06F 21/40

(52) U.S. Cl. CPC G06Q 20/3674; G06Q 20/363; G06Q 20/40145; G06F 21/40

(57) ABSTRACT

Systems and methods are provided for providing verified claims, based on multiple credentials, to relying parties. One example method includes receiving, by a computing device, a request for identity claims from a relying party. The method also includes, in response to the request, soliciting an authentication input from the user, authenticating the user based on the authentication input received from the user at the computing device, and, in response to authentication of the user, compiling, from multiple credentials included in the computing device, the identity claims included in the request. The method then includes sharing the determined identity claims with the relying party.

### FIELD

The present disclosure is generally directed to systems and methods for use in managing complex user credentials in computing networks, and more specifically, to systems and methods for use in providing verification of complex user credentials in connection with user authentication.

### BACKGROUND

This section provides background information related to the present disclosure which is not necessarily prior art.

Users are known to be associated with user credentials indicative of identities. The identities are generally specific to the users and often include their names, government-based identifiers (e.g., social security numbers, etc.), mailing addresses, residential addresses, phone numbers, email addresses, credit scores, dates of birth, etc. The attributes are generally provided through physical documents that contain the attributes, such as, for example, driver's licenses or passports. Consequently, users may make claims about their names, government ID numbers, etc., and present the physical document(s) to permit relying parties to verify the claims. More recently, digital identities have become available, whereby relying parties request the attributes for the users, or verification of the users' claims, from identity providers or IDPs associated with managing or maintaining digital identities of the users.

### DRAWINGS

The drawings described herein are for illustrative purposes only of selected embodiments and not all possible implementations, and are not intended to limit the scope of the present disclosure.

FIG. 1 is an example system of the present disclosure suitable for use in managing complex user claims associated with users based on multiple credentials;

FIG. 2 is a block diagram of a computing device that may be used in the example system of FIG. 1;

FIG. 3 is an example method, which may be implemented in connection with the system of FIG. 1, for use in provisioning credentials to a digital wallet, which are authenticated alone or based on other provisioned credential(s), and managing complex user claims related to the same; and

FIG. 4 is an example method, which may be implemented in connection with the system of FIG. 1, for use in providing a verified complex user claim, based on multiple credentials, to a relying party.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Users identities may include any number of attributes. The attributes may include, without limitation, names of the users, mailing addresses, residential addresses, email addresses, government ID numbers, payment account numbers, dates of birth, etc., which may be shown or included on one or more physical documents (broadly, credentials), etc. The identity attributes may further extend to airplane tickets or other tickets (e.g., confirmation numbers, etc.), passes, membership or group ID numbers, entity ID numbers (e.g., employee IDs, student IDs, etc.), etc. These attributes may also be shown on physical or electronic documents, such as tickets, e-tickets, reservations, membership cards, etc. Relying parties may require separate physical electronic documents (in person or through emails or applications of users' smart phones, etc.) to evidence each attribute that the relying parties intend to rely on, whereby the users may have to present passports, tickets, and also proof of travel insurance, etc. In connection therewith, though, the presentment of the multiple documents, as well as the preservation of such documents, provides for friction in presenting claims (by the users) (e.g., assertions of attributes (e.g., an assertion of user names, etc.), etc.) to the relying parties, which results in inefficiencies especially where the relying parties are required to evaluate the claims across multiple physical documents.

Uniquely, the systems and methods herein provide for verification of complex user claims made by users, through digital identities of the users, by relying on multiple credentials within the digital identities. In particular, as credentials are provisioned to a digital identity for a user, an identity of the user is compiled based on the different attributes in the different credentials. For example, one credential may include certain attributes for the user, while another credential may have different attributes for the user and one common attribute (e.g., a name, etc.). A complex claims orchestrator (CCO), then, is configured to compile complex user claims based on multiple credentials associated with the user, in response to a relying party, for example, whereby the claims are verified to the relying party, but without presenting each of the separate credentials, in total, to the relying party. In this manner, the CCO is permitted to respond to requests for the complex user claims from the relying party, yet maintain other personal identifying information of the user on the credential which is not needed and/or requested by the relying party.

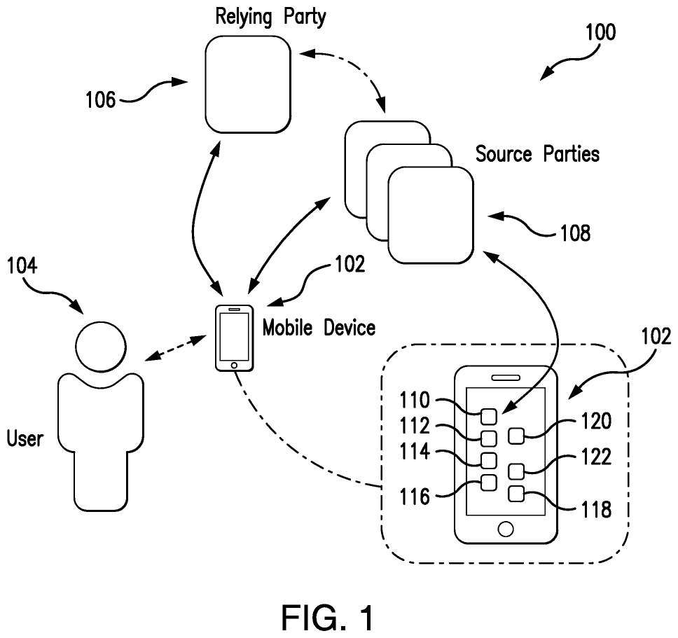

FIG. 1 illustrates an example system 100 in which one or more aspects of the present disclosure may be implemented. Although the system 100 is presented in one arrangement, other embodiments may include the parts of the system 100 (or other parts) arranged otherwise depending on, for example, relationships between users and parties, numbers of relying parties, types of interactions between users and relying parties, data privacy requirements and/or regulations, etc.

The system 100 generally includes a mobile device 102 associated with a user 104, a relying party 106, and source parties 108 (broadly, sources), each of which is coupled in communication via one or more networks (e.g., as indicted by the arrowed lines, etc.). The one or more networks may each include one or more of, without limitation, a local area network (LAN) (e.g., a peer-to-peer network via a hotspot, Bluetooth low energy (BLE) or near-field communication (NFC), etc.), a wide area network (WAN) (e.g., the Internet, etc.), a mobile network, a virtual network, and/or another suitable wired or wireless, public and/or private network capable of supporting communication among two or more of the parts illustrated in FIG. 1, or any combination thereof.

The mobile device 102 includes any suitable device, which is mobile with the user 104 as the user 104 moves from location to location. In this exemplary embodiment, the mobile device 102 is illustrated as a smartphone. However, the mobile device 102 may be a different device in other embodiments, including, for example, a laptop computing device, a tablet device, a smart speaker, a smart home device, a wearable device (e.g., a smartwatch, a fitness tracker, etc.), etc. In addition, the mobile device 102 may also include a variety of applications installed thereon. For instance, the illustrated mobile device 102 includes an identity application 110, a university application 112, a bank application 114, a public transit application 116, an airline application 118, and a digital wallet 120. It should be appreciated that, in other embodiments, the number and/or types of applications included in the mobile device 102 may be different. For example, a mobile device may include ones of the above applications, but not all of the applications, and/or one or more other applications not included above. In general, however, the applications included at the mobile device 102 may be related to and/or relied on for one or more attributes of the identity of the user 104, as described in more detail herein.

Each of the applications 110-120 included at the mobile device 102 include computer-executable instructions, which are stored in the mobile device 102 and, when executed, cause the mobile device 102 to perform operations indicated by the type of the given application. For example, the identity application 110 may cause the mobile device 102 to, among other things, capture credentials associated with the user 104 and store the credentials (or parts thereof) in the digital wallet 120. The university application 112 may cause the mobile device 102 to, among other things, allow the user 104 to apply for student passes, enroll in classes, view grades, view and/or pay financial requirements, etc., and the bank application 114 may cause the mobile device 102 to, among other things, permit the user 104 to view balance information, to apply for credit or other accounts, etc. The public transit application 116 may cause the mobile device 102 to, among other things, permit the user 104 to purchase and present passes for transit, etc. The airline application 118 may cause the mobile device 102 to, among other things, permit the user 104 to purchase tickets and present tickets for boarding a flight, etc. And, the digital wallet 120 may cause the mobile device 102 to, among other things, permit the user to pay for products and/or services purchased from a merchant, etc. and operate as a location to hold credentials as described herein, etc.

In this exemplary embodiment, the applications 110-118 generally reside in an operating system (OS) application environment of the mobile device 102. And, the digital wallet 120 is included in a memory of the mobile device 102, such as, for example, a trusted execution environment (TEE) or secure element (SE).

In addition in the system 100, the mobile device 102 includes a complex claim orchestrator (CCO) 122, which includes computer-executable instructions stored in memory and executable by the mobile device to cause the mobile device 102 to operate as described in more detail below. The CCO 122 may include a software development kit (SDK) included in part, or in whole, in one or more of the applications 110-118 and/or in the digital wallet 120, or as a standalone application in the mobile device 102. In this embodiment, the CCO 122 is included, mainly, in the identity application 110, but may be included, in whole or in part, as an SDK in each of the other applications 112-118 and/or digital wallet 120 to permit interactions described below. In at least one embodiment, the CCO 122 may be included, at least in part, in a backend associated with the mobile device 102, whereby the interactions herein can be segregated between the backend and the mobile device 102, as appropriate.

The user 104 in the system 100 is associated with an identity, which, in general, distinguishes the user 104 from other persons. The identity includes a number of different attributes. Some attributes are generally static, such as, for example, the user's given name, surname, government ID number, date of birth (DOB), place of birth, gender, height, eye color, hair color, phone number, email address, employer ID numbers, street address, education (e.g. degrees, etc.), biometrics, etc. Other attributes may be transitory, such as, for example, airline ticket information (e.g., travel name, flight number, seat number, airline, issuing authority, departure airport, destination airport, etc.), train or bus tickets issued to the user 104, appointments/reservations, etc. And certain attributes may be associated with the credentials of the user 104, including, for example, issuing authorities of the credentials, document numbers, issue dates for the credentials, expiration dates of the credentials, etc.

In general, the identity of the user 104 is evidenced or proven by one or more physical documents, or one or more verifications from an authority. For example, a name, address, and passport number, among other things, may be proven by presentation of a passport. The passport serves as proof until it expires. A college degree and a date of birth (and a place of birth) may be evidenced by a diploma and a birth certificate, respectively. Similarly, a driver's license may be evidence of a driver's license number, street address, height, eye color, and a biometric (e.g., facial image, etc.), while a student ID may be evidence of a student ID number of the user 104 and a biometric (e.g., a facial image, etc.), etc. Also, an email address or phone number being associated with the user 104 may be evidenced by (or verified by) the user 104 returning a passcode issued (e.g., emailed, messaged, etc.) to the email address or mobile phone, etc. It should be appreciated that further examples of physical documents, or verifications, may be relied on in connection with the operations described herein.

The relying party 106 in the system 100 may include an entity, with which users (including the user 104) interact based, at least in part, on identities of the users. For example, the relying party 106 may include, without limitation, an employer offering employment to users; a merchant offering products and services for sale; a transit provider offering users tickets or passes; a school or university enrolling users as students; an insurance provider offering health insurance, automobile insurance, home owners insurance, etc. to users; a financial institution (e.g., a bank, etc.) offering credit accounts, mortgage accounts, etc. to users; etc.

It should be appreciated that the mobile device 102 may be configured to communicate with the relying party 106, as a separate entity (apart from the mobile device 102), directly or via an application associated with the relying party 106 and included in the mobile device 102, etc. For example, the university application 112 may be associated with a university relying party, at which the user 104 is enrolled, and the bank application 114 may be associated with a banking relying party, from which the user 104 has or may request an account. And, the public transit application 116 may be associated with a public transit relying party, from which the user 104 has or may purchases transit passes, while the airline application 118 may be associated with an airline relying party, from which the user 104 has or plans to purchase an airline ticket to a destination (for the user 104 and the family of the user 104, for example).

In connection therewith, then, and as indicated above, one or more of the applications 110-118 may also include a SDK associated with the CCO 122, which configures the mobile device 102 to provide communication between the applications 110-118 and the digital wallet 120, in general and further for the operations described herein. In the absence of an SDK, the one or more of the applications 110-118 may be otherwise configured, separately, to communicate with the digital wallet 120 and/or the CCO 122. Further, in one or more embodiments, the identity application 110, the digital wallet 120, and/or the CCO 122 may be included as part of the same application (or not) (and stored/executed in application memory and the TEE (or SE) of the mobile device 102 as appropriate), or included together as part of an SDK in another application.

It should be further appreciated that while the CCO 122 is illustrated in the mobile device 102 in FIG. 1, the CCO 122 may be included in part in the mobile device 102 and in part in a cloud service or a server associated with the CCO 122 (and in communication with the mobile device 102) (not shown), etc. in other system embodiments.

With continued reference to FIG. 1, each of the source parties 108 in the system 100 may be a backend party associated with one of the applications 110-118. For example, one of the source parties 108 may include a college or university associated with the university application 112; another one of the source parties 108 may be a bank associated with the bank application 114; still another one of the source parties 1108 may include the transit provider associated with the public transit application 116; and/or a further one of the source parties 108 may include an airline associated with the airline application 118; etc. That said, the source parties 108 may include any party or entity that interacts with the user 104 (and/or other users) to provide and/or issue credentials to be included in the digital wallet 120 in the mobile device 102. Further, as indicated by the dotted line in FIG. 1 between the relying party 106 and the source parties 108, it should be appreciated that the relying party 106 and the source parties 108 may be the same in certain instances. For example, where a source party issues a plane ticket to the user 104 from one city to another, and then requires the user 104 be authenticated to a ticket at boarding, the airline is both a relying party 106 (at boarding) and a source party 108 (when the ticket is sold and provisioned to the digital wallet 120, for example, and verified). The mobile device 102 may be configured to communicate with the sources parties 108, as described below, directly (e.g., via an API, etc.), or via one or more of the applications included in the mobile device 102, etc.

In operation of the system 100, the mobile device 102 is configured, by the CCO 122, to provide complex identity claim operations for the user 104, for example, in connection with verifying an identity claim of the user 104, etc.

Initially, the mobile device 102 is configured by the CCO 122 to provision one or more credentials to the digital wallet 120. For example, the mobile device 102 may be configured, by the identity application 110, to receive an instruction from the user 104 to enroll a credential (e.g., driver's license, passport, etc.). In response, the mobile device 102 is configured, by the identity application 110, to seek/receive consent to provision the credential to the digital wallet 120 and to solicit/capture an image of the credential. The mobile device 102 is also configured, in this example, by the identity application 110, to solicit/capture a biometric, such as a selfie, etc., of the user 104. Thereafter, in this example, the mobile device 102 is configured, by the identity application 110, to verify liveness of the user based on the captured biometric and/or to verify the user 104 based on comparing the captured biometric to the image of the credential (e.g., compare the selfie of the user 104 to an image included in the credential, etc.). The mobile device 102 may further be configured to compare the content of the credential to content of credentials already included in the digital wallet 120 (e.g., a name of the user 104, an address of the user 104, etc.) (broadly, resolve the credential against known credentials). When verified (and confirmed live), the mobile device 102 is configured, by the identity application 110, to issue the credential into the digital wallet 120 (e.g., as an electronic credential, etc.) along with a biometric authentication attribute to the CCO 122.

In turn, the mobile device 102 is configured, by the CCO 122, to generate an identity claim(s) (included in and/or based on the attributes of the identity from the credential) (e.g., an assertion of an attribute associated with the user 104 (e.g., an assertion of the user's name, etc.), etc.), which is linked to the authentication attribute (e.g., the selfie or other biometric, etc.) and the credential, and to provision or store the identity claim, along with the authentication attribute, in the digital wallet 120 (e.g., in memory of the mobile device 102 associated with the digital wallet 120, etc.). For example, for a driver's license credential provided to the CCO 122, the CCO 122 may generate multiple identity claims including one identity claim for the user's name, another identity claim for the user's date of birth, and still another identity claim for the user's driver's license number (all of which may be based on the information included in the user's driver's license). In another example, for a government ID credential provided to the CCO 122, the CCO 122 may generate an identity claim for a government ID number included on the government ID credential, etc. As will be described, each identity claim can then be linked to the particular credential upon which it is based and potentially linked to other credentials including attribute(s) indicative of the identity claim(s).

It should be appreciated that, in some instances, the credential may be provisioned to the digital wallet 120 entirely based on one or more credentials already included in the digital wallet 120. For example, the user 104 may instruct the mobile device 102 to provision a diploma to the digital wallet 120. Unlike a driver's license or passport, though, the diploma, in general, does not include an image of the user 104 (or other biometric of the user 104). As such, the mobile device 102 is configured to leverage the passport credential already in the digital wallet 120 to verify the name on the diploma against the name on the passport. In response to a match (and general authentication of the user 104 based on a selfie), the mobile device is configured, by the CCO 122 and/or the identity application 110 (as described above) to generate an identity claim for a specific degree included on the diploma and to provision the diploma as a credential (linked to the passport, as the basis for verification) to the digital wallet 120, whereby the specific degree becomes part of the user identity in the digital wallet 120.

With that said, credentials may include any type of credential associated with a user, and/or by which a user and/or information for a user may be identified or gleaned. For example, the credentials may include, without limitation, driver's licenses, passports, payment cards (e.g., credit cards, debit cards, prepaid cards, bank cards, etc.), student ID cards, club cards (e.g., loyalty cards, etc.), employee ID cards (e.g., proofs of employment, etc.), certificates, certifications, diplomas, tickets (e.g., airplane tickets, performance tickets (e.g., sports, theatre, etc.), etc.), travel passes, health records (e.g., vaccination records, testing records, etc.), proofs of insurance, government IDs, membership cards, birth/marriage/divorce certificates, deed polls, transaction credentials (e.g., transaction information, credit scores, payment histories, balances, available credit, receipts, proofs of purchase, etc.), property deeds, digital receipts, digital keys, photos, biometric templates, self-asserted data and preferences, etc.

As additional credential(s) are added to the digital wallet 120, the mobile device 102 is configured, by the CCO 122, to build or resolve, over time, the identity of the user 104 as the identity in the digital wallet 120, with each identity claim by the user 104 and/or attribute of the user's identity associated with at least one credential, and certain credentials linked to authentication of certain attributes (as authenticated attributes, etc.).

Further, in linking the attributes of the identity of the user 104 to the specific credentials, the mobile device 102 is also configured, by the CCO 122 (or the digital wallet 120) in this embodiment, to associate a validity interval with the credential(s), whereby the mobile device 102 is configured to designate the credential(s) as expired or ineffective after the validity interval, etc. For example, a passport may expire on May 1, whereby the validity interval is defined by the expiration date so that the passport is not relied on by the mobile device 102 on or after May 2. The validity period, likewise, for an airline ticket, may be the date of departure, etc.

Moreover, issuers of the credentials may digitally sign the credentials using private keys, and then publish corresponding public keys (e.g., to blockchain or other trusted public utilities, etc.) to allow verification of integrity of the credentials. For instance, when the mobile device 102 is configured by the identity application 110 (and/or a backend associated therewith) to issue the credential, for example, a driver's license of the user 104, etc., to the digital wallet 120 or CCO 122 (e.g., upon receiving a scan thereof, upon retrieving the credential from an identity provider, etc.), the mobile device 102 (e.g., the identity application 110, CCO 122, and/or corresponding backend, etc.) may also be configured to sign the credential by a private key of the identity application 110 (and/or backend) (as an issuer of the credential to the digital wallet 120, etc.) and publish a corresponding public key to a repository (e.g., at a payment network or identity provider computing device (e.g., implemented as blockchain or other suitable immutable or mutable data structure(s), etc.), etc.), or otherwise. Consequently, thereafter, upon receipt of an attribute inquiry or request for an identity claim associated with (or linked to) the credential, by the relying party 106, the issuer of the credential may be identified by the relying party 106 (e.g., by a particular ID associated with the identity application 110 and provided by the mobile device 102 to the relying party 106 as part of the response to the request, etc.).

In turn, the relying party 106 may then retrieve the appropriate public key(s) from the data structure(s) and use it/them to confirm integrity of a corresponding identity claim received from the mobile device 102 (via the digital wallet 120, etc.). It should be appreciated that each of the other applications 112-118 (and/or a backend associated therewith) may similarly be issuers of credentials in the same manner described above, and may thereby sign the credentials with private keys and further publish the public keys to permit verification of the credential(s), as described.

That said, it should be appreciated that the user 104 may be one or multiple users having an identity include in the digital wallet 120. The multiple users may be members of a family, a social cohort of the user 104, or other members of a group, who may have need to present their identities together, or at one time or otherwise, etc.

In leveraging the identity of the user 104 in the digital wallet 120, the mobile device 102 may be configured to provide multiple attributes, or confirmation thereof, from multiple different credentials, to one of the applications 110-118 in the mobile device 102 (as a relying party), and/or to the relying party 106 apart from the mobile device 102.

In particular, for example, when the relying party 106 is an airline, and the user 104 is attempting to board a plane, the relying party 106 may request, form the user 104, proof of the user's identity, a plane ticket, and proof of medical insurances. In response, the user 104 accesses the CCO 122, in the mobile device 102, and presents the mobile device 102 to the relying party 106. In response, the relying party 106 is configured to request the above information from the mobile device 102.

In turn, the mobile device 102 is configured, by the CCO 122 and/or the digital wallet 120, to authenticate the user 104 (e.g., based on a biometric (e.g., as the authentication attribute in the digital wallet 120, etc.), etc.) and to verify any of the requested credentials with a relying party, as needed (e.g., the airplane ticket credential may be verified at boarding to confirm no changes, etc. via the airline application 118 in the mobile device 102 or directly with the relying party; etc.). The mobile device 102 is configured, by the CCO 122 and/or the digital wallet 120, to then compile a response to the request from the relying party 106, whereby the mobile device 102 is configured to consult the individual credentials in the digital wallet 120 (e.g., plane ticket credential, passport or driver's license credential, and medical insurance credential, etc.) and to build the response to include suitable information, such as, for example, a name and seat number, etc. In turn, the mobile device 102 is configured, by the CCO 122, to present and/or transmit a confirmation and the suitable information to the relying party 106 (e.g., by transmitting or displaying the confirmation, or the underlying requested claims for the user 104, etc.).

It should be appreciated that the mobile device 102 may be configured, by the CCO 122, to impose and/or asses policies associated with the credential(s), and sharing the credential(s) with the relying party 106, before sharing the identity claims. For example, an issuing authority of a credential (e.g., a source party 108, etc.) may require an interaction with the relying party 106 (e.g., paying associated fees or subscriptions, etc.) prior to the CCO 122 sharing the identity claim with the relying party 106.

Further, in some instances, in compiling a response to a request by the relying party 106 for an identity of the user 104 (and/or other information relating to the user 104), the mobile device 102 may be configured, by the CCO 122 and/or the digital wallet 120, to include a level of assurance or level of confidence (e.g., a strength, a score, etc.) in the identity (and/or other information) being returned to the relying party 106.

The level of assurance or level of confidence may be based on a number of credentials used and/or available for use in providing the requested information to the relying party 106, and/or on the types of credentials used and/or available, etc. For instance, in the above example, where the relying party 106 is an airline, the mobile device 102 may be configured to provide a response to the relying party 106 that includes a name of the user 104, a date of birth of the user 104, an airline and flight number for the flight booked by the user 104, and a seat number for the flight (as identity claims, etc.). In doing so, the mobile device 102 may consult a passport, a driver's license, and a birth certificate for the user's name and date of birth, and the ticket purchased by the user 104 for the airline, flight number and seat number. And then, in responding to the request by the relying party 106, the mobile device 102 may be configured to generate a confidence score (based on the credentials relied on and/or an independent confidence score for each of the credentials relied on, etc.), whereby in this example, a relatively high confidence score (e.g., 95/100, etc.) for the user's name and date of birth (based on use of the three total credentials and use of the particular credentials (passport and driver's license), and a medium confidence (e.g., 65/100, etc.) for the user's airline, flight number and seat number (based on use of only one credential) may be provided.

In this manner, the relying party 106 is configured to receive confirmation of the identity of the user 104, the purchase of the plane ticket (and seat number), and the medical insurances (broadly, a complex claim based on multiple credentials), generally, without having to review and resolve separate credentials for each piece of information (e.g., a passport, a ticket, and a medical insurance card, etc.), or even access/view the personal identifying information thereon.

While only one mobile device 102, one user 104, one relying party 106, several applications 110-118, one digital wallet 120, and three source parties 108 are illustrated in the system 100, it should be appreciated that additional ones of these parts/users may be, and likely would be, included in other system embodiments. In connection therewith, the mobile device 102 may include more or less applications therein, each linked or in communication, or not, as described above.

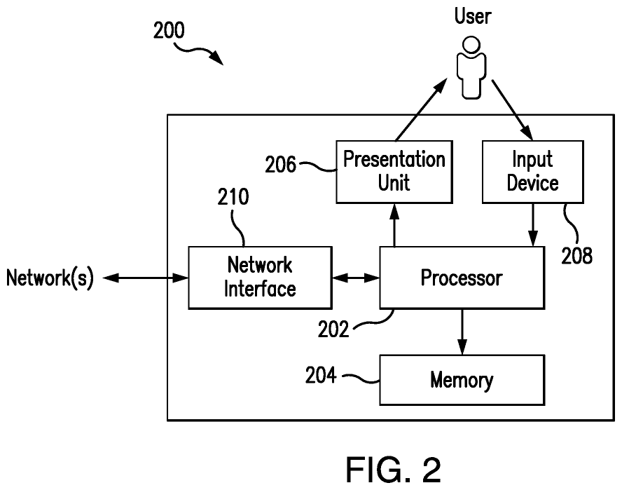

FIG. 2 illustrates an example computing device 200 that can be used in the system 100 of FIG. 1. The computing device 200 may include, for example, one or more servers, workstations, personal computers, laptops, tablets, smartphones, virtual devices, etc. In addition, the computing device 200 may include a single computing device, or it may include multiple computing devices located in close proximity or distributed over a geographic region, so long as the computing devices are specifically configured to function as described herein. In the example embodiment of FIG. 1, each of the mobile device 102, the relying party 106, and each of the source parties 108 may include or may be implemented in a computing device consistent with the computing device 200 (coupled to (and in communication with) the one or more networks of the system 100). However, the system 100 should not be considered to be limited to the computing device 200, as described below, as different computing devices and/or arrangements of computing devices may be used in other embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, identity details and data related to identities of users, listings of sources and data associated therewith, rules, preferences, historical data, behavior and intention data, authentication policies and/or other types of data (and/or data structures) suitable for use as described herein.

Furthermore, in various embodiments, computer-executable instructions (e.g., in the form of the identity application 110 and/or an SDK therein, etc.) may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 and/or other computer system components configured to perform one or more of the various operations herein, whereby upon performance of the same the computing device 200 may be transformed into a special purpose computer system. It should be appreciated that the memory 204 may include a variety of different memories, each implemented in one or more of the functions or processes described herein.

In the example embodiment, the computing device 200 also includes a presentation unit 206 that is coupled to (and is in communication with) the processor 202 (however, it should be appreciated that the computing device 200 could include output devices other than the presentation unit 206, etc.). The presentation unit 206 outputs information, visually or audibly, for example, to a user of the computing device 200 (e.g., the user 104, etc.) (e.g., solicit inputs, display outputs (e.g., confirmations, identity attributes, etc.), etc.) whereby the information may be displayed at (or otherwise emitted from) computing device 200, and in particular at presentation unit 206. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user of the computing device 200 (i.e., user inputs) such as, for example, authentication inputs (e.g., biometrics, etc.), requests to provision credentials, requests to confirm, verify or share data, etc. as further described below. The input device 208 may include a single input device or multiple input devices. The input device 208 is coupled to (and is in communication with) the processor 202 and may include, for example, one or more of a keyboard, a pointing device, a mouse, a camera, a touch sensitive panel (e.g., a touch pad or a touch screen, etc.), another computing device, and/or an audio input device. In various example embodiments, a touch screen, such as that included in a tablet, a smartphone, or similar device, may behave as both the presentation unit 206 and an input device 208.

Further, the illustrated computing device 200 also includes a network interface 210 coupled to (and in communication with) the processor 202 and the memory 204. The network interface 210 may include, without limitation, a wired network adapter, a wireless network adapter (e.g., a NFC adapter, a Bluetooth adapter, etc.), or other device capable of communicating to one or more different networks herein and/or with other devices described herein. Further, in some example embodiments, the computing device 200 may include the processor 202 and one or more network interfaces incorporated into or with the processor 202.

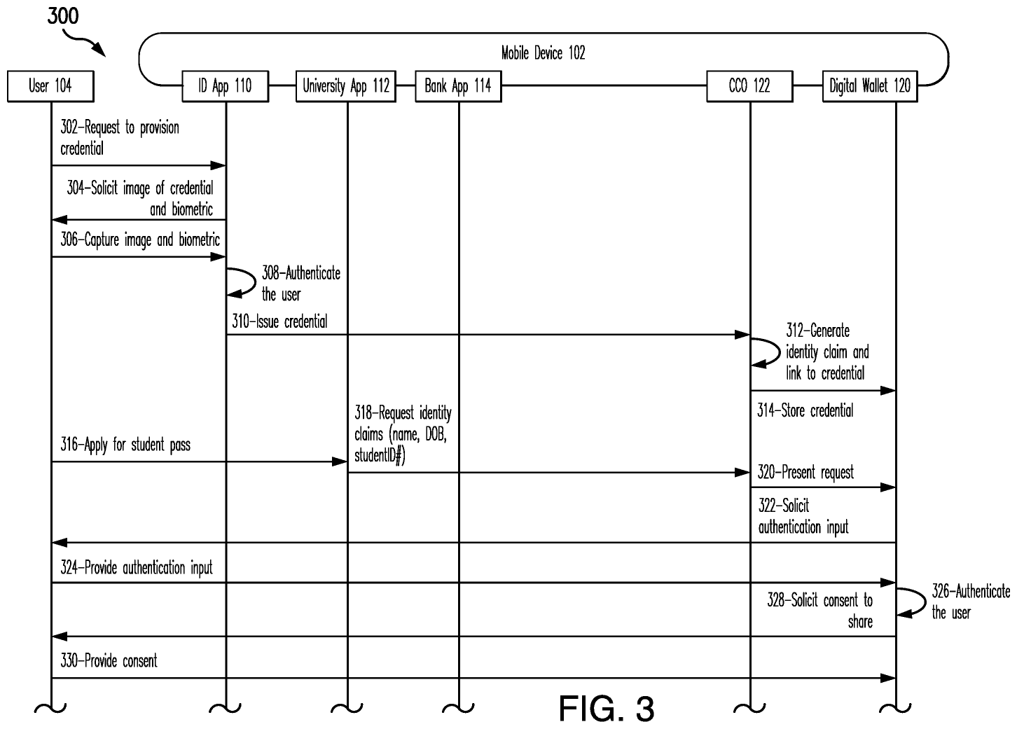

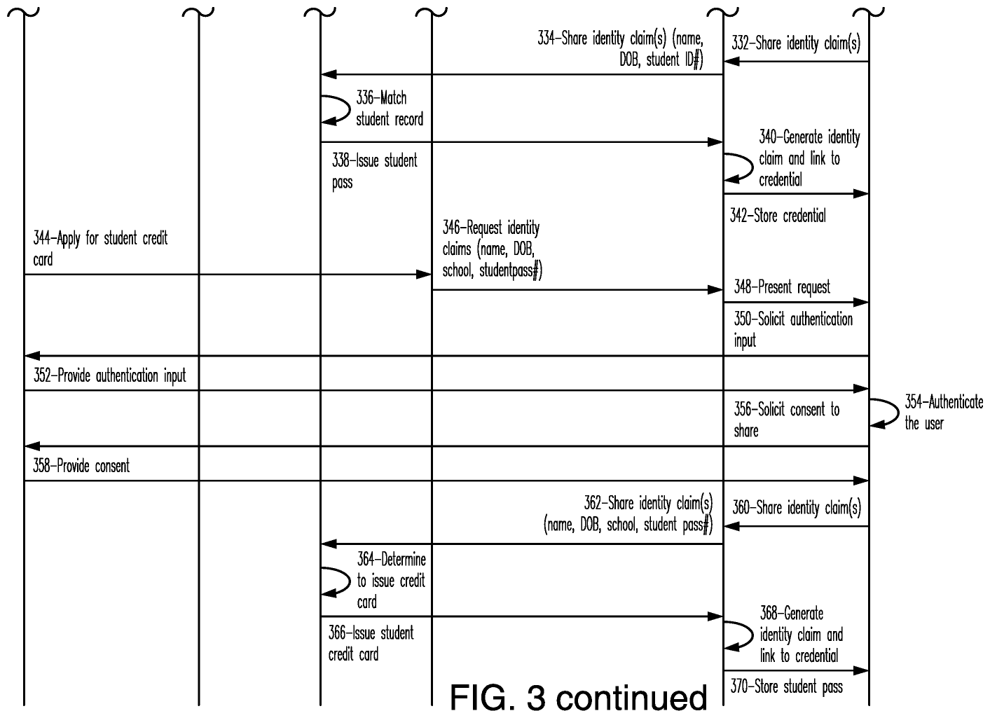

FIG. 3 illustrates an example method 300 for use in generating one or more claims associated with a user, each based on multiple credentials. The example method 300 is described as implemented in the mobile device 102 and other aspects of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 300.

At the outset in the method 300, it should be appreciated that the user 104 is associated with an identity, which is evidenced by multiple different credentials. The identity is composed of attributes, where certain of the attributes are included on some credentials and other attributes in other credentials.

At 302, the user 104 requests to provision a credential, such as a passport or driver's license, etc., to the digital wallet 120, via the identity application 110. In response, the mobile device 102 solicits, at 304, an image of the credential and a biometric of the user 104 (e.g., a selfie, etc.). The user 104, in turn, uses the mobile device 102 to capture the image of the credential and the biometric, at 306. While an image of the credential is appropriate for a passport, for example, the mobile device 102 may capture other data from the credential in other instances. For example, where the credential is a smartcard ID, the mobile device 102 may capture, through NFC, Bluetooth, or other wireless connection, or wired connections (or insertions), etc. data from the smartcard ID (e.g., identity attributes, biometric references, etc.), and further capture any suitable type of biometric from the user 104 (e.g., fingerprints, etc.).

Thereafter, at 308, the mobile device 102, by the identity application 110, authenticates the user 104 based on the captured credential and the captured biometric. For example, the mobile device 102 may employ a liveness detection in connection with capturing the selfie of the user 104 (e.g., to ensure the captured image is from a live user, rather than a picture, etc.), and then compare the captured selfie to the image of the user 104 included in the credential (e.g., a picture of the user on a driver's license, or passport, etc.), whereby the user 104 is verified based on a match (within acceptable industry standards for determining such match). In addition, although not shown, the mobile device 102, as caused by the identity application 110, may also (e.g., after the user 104 is authenticated, etc.) sign the credential by a private key (as an issuer of the credential, etc.), prior to issuing the credential (at 310), and publish a corresponding public key to a repository (e.g., at a payment network or identity provider computing device associated with the identity application 110, etc.), or otherwise. In this manner, when the credential is relied upon to respond to an identity request by a relying party (e.g., the university application 112 in the below example, etc.), the relying party is able to identify the issuer of the credential and verify the response.

It should be appreciated that the mobile device 102 may further solicit consent and other data from the user 104 in connection with the request to provision the credential to the digital wallet 120. For example, at the time the credential is provisioned, the user 104 may define one or more conditions under which the credential may be used, etc.

With continued reference to FIG. 3, in response to the authentication (and consent, if provided and/or relevant, and publication of the private key (if provided)), the mobile device 102, by the identity application 110, issues, at 310, the credential to the CCO 122, along with the authentication attribute (e.g., the selfie, etc.). In response, the CCO 122 generates an identity claim and links the identity claim to the credential, at 312. More specifically, the CCO 122 pulls the attributes of the user's identity from the credential (e.g., name, mailing address, birthdate, driver's license number, etc.), adds the attributes to the identity of the user 104 (in the mobile device 102), and then links the attributes to the specific credential being provisioned, and the authentication attribute used to authenticate the user 104 to provision the credential (e.g., the selfie, etc.). The credential (more specifically, the identity claim and authentication attribute) is then stored, at 314, by the mobile device 102 in the digital wallet 120 (e.g., as signed by the identity application 110, etc.). The credential may support one or multiple identity claims. For example, where the credential is a driver's license of the user 104, it may support an identity claim for a name of the user 104, an identity claim for a residential address for the user 104, an identity claim for a date of birth of the user 104, and an identity claim for a driver's license number for the user 104, etc. And, the credential, as issued to the CCO 122 and/or digital wallet 120, then supports the various identity claims (and can be used to verify later requests for such identity claims).

It should be understood that the above steps of method 300, in whole or in part, may be repeated to provision multiple different credentials to the digital wallet 120 (and generate multiple additional identity claims and/or link one or more of the additional credentials to existing identity claims), and that the authentication of the user 104 may be based on one or more credential already provisioned to the digital wallet 120 and accessed by the CCO 122 to authenticate the credential being newly provisioned (e.g., use the authentication attribute of the passport already provisioned to subsequently provisioned an insurance card having the same name, etc.). Additionally, or alternatively, it should be appreciated that the above steps of method 300, in whole or in part, may be employed to provision a credential to the digital wallet 120, through other applications depending on the type of credential, including, such as, for example, an airplane ticket through the airline application 118, and a credit card credential through the bank application 114, etc.

Then in the method 300, in this embodiment, the user 104 requests a student pass to be issued and provisioned to the digital wallet 120. At 316, therefore, the user 104 applies for the student pass, via the university application 112. In response, at 318, the university application 112 requests one or more identity claims from the CCO 122, and specifically, in this example, the name, date of birth and student ID number of the user 104.

The CCO 122, as part of the mobile device 102, then presents, at 320, the request for the one or more identity claims to the digital wallet 120. The digital wallet 120 then solicits an authentication input from the user 104, at 322. At 324, the user 104 provides the authentication input to the mobile device 102. The authentication input may be consistent, for example, with the authentication attribute included in the digital wallet 120 (as provisioned above), or not. In response, the digital wallet 120 authenticates the user 104 based on the authentication input, at 326, and then solicits consent from the user 104, at 328, to share the specific identity claims with the university application 112 (broadly, as a relying party 106 in this example). The user 104 provides, at 330, the consent. In turn, based on the authentication of the user 104 and the consent from the user 104, the digital wallet 120 retrieves the identity claims from (and/or associated with) the relevant credential(s) (e.g., the name and DOB from a driver's license credential and the student ID number from a student ID credential, etc.) and then shares, at 322, the identity claims(s) (e.g., name, DOB, student ID number, etc.) with the CCO 122. The CCO 122, in turn, shares, at 334, the identity claims with the university application 112 (and potentially, to a backend associated therewith, via the university application 112 or directly). In addition, in some embodiments, the CCO 122 may optionally share an identifier associated with the issuing party of the credential(s), whereby the university application 112 is able to identify a public key associated with one or more of the credentials upon which the identity claims are based and verify the credentials (and, thus, the identity claims received from the CCO 122).

The university application 112, directly or via the backend, matches, at 336, the identity claim(s) to a student record (generally, at the backend of the university application 112 (e.g., a university or college, etc.)) (and an identifier of the identity application 110 as the issuer of the credential upon which the identity claims are based). Optionally, the university application 112 may further verify the credential associated with the identity claims based on the identifier from the CCO 122, by retrieving a public key associated with the issued credential from a repository and verify the credential. And then, in response to a match, the university application 112 issues, at 338, a student pass for the user 104 to the CCO 122. The CCO 122 generates, at 340, another identity claim for the student pass (as the attributes(s)) (e.g., student pass number, user name, school name, student ID #, etc.) and links the student pass as a credential to the identity claim(s) and the underlying credential(s) (e.g., also linked to the driver's license and the student ID credential (and associated expiration dates)). And then, at 342, the CCO 122 stores the credential (e.g., the student pass, etc.) (including the student pass attribute(s)) in the digital wallet 120. In connection therewith, the credential may be signed by the issuer thereof (via a private key), for example, the university application 112 or a corresponding backend, etc. (and which then potentially publishes a corresponding public key to a repository, or otherwise).

Next in the method 300, in this embodiment, the user 104 requests that a student credit card be issued and provisioned to the digital wallet 120. At 344, therefore, the user 104 applies for the student credit card, via the bank application 114. In response, at 346, the bank application 114 requests one or more identity claims from the CCO 122, and specifically, in this example, the name, date of birth, school name, and student pass number of the user 104 (e.g., for the pass issued at 338, etc.).

The CCO 122, as part of the mobile device 102, then presents, at 348, the request for the one or more identity claims to the digital wallet 120. The digital wallet 120 solicits an authentication input from the user 104, at 350. At 352, the user 104 provides the authentication input to the mobile device 102. The authentication input may be consistent, for example, with the authentication attribute included in the digital wallet 120 (as provisioned above), or not. In response, the digital wallet 120 authenticates the user 104 based on the authentication input, at 354, and then solicits consent from the user 104, at 356, to share the specific identity claims with the bank application 114 (broadly, as a relying party 106). The user 104 provides, at 358, the consent. In turn, based on the authentication of the user 104 and the consent from the user 104, the digital wallet 120 retrieves the identity claims from the relevant credential(s) (e.g., the name and DOB from a passport credential and the student pass number and school name from a student pass credential, etc.) and then shares, at 360, the identity claims(s) (e.g., name, DOB, student name and school pass number, etc.) with the CCO 122. The CCO 122 shares, at 362, the identity claims with the bank application 114 (and potentially, to a backend associated with the bank application 114, via the bank application 114 or directly). Again, optionally, the CCO 122 may also share an identifier associated with the issuer(s) of the credentials used for the given identity claims, whereby the bank application 114 is able to identify a public key (or keys) associated with one or more credentials upon which the identity claims are based and verify the credentials.

Then, the bank application 114, directly or via the backend, determines, at 364, whether to issue the student credit card (e.g., based on conventional metrics, etc.) and then, as appropriate, the bank application 114 issues, at 366, the student credit card to the CCO 122. The CCO 122 generates, at 368, an identity claim for the student credit card (as the attributes(s)) (e.g., name, PAN, expiration date, CVC, etc.) and links the student credit card as a credential to the identity claim(s) and the underlying credential(s) (e.g., linked to passport and student pass credentials (and associated expiration dates)). And then, at 370, the CCO 122 stores the credential (e.g., the student credit card, etc.) (including the associated attribute(s)) in the digital wallet 120, for later use (and, again, as potentially signed by the issuer of the credential via a private key and whereby a corresponding public key is published to a repository, or otherwise).

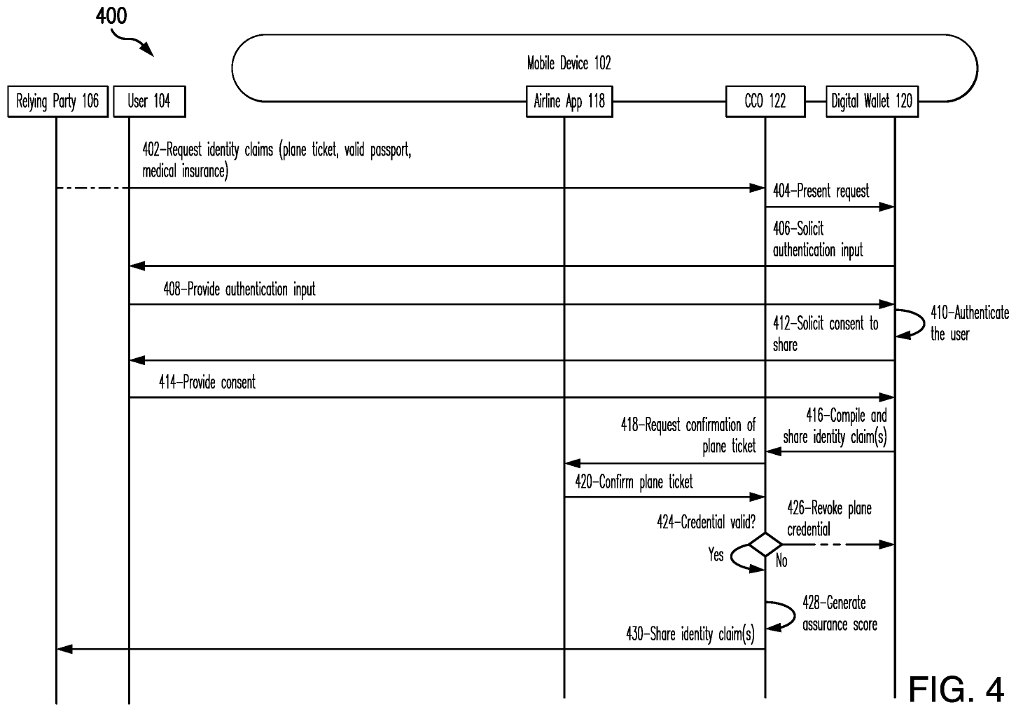

FIG. 4 illustrates an example method 400 for use in sharing one or more claims for a user, where the one or more claims are each based on multiple credentials. The example method 400 is described as implemented in the mobile device 102 and other aspects of the system 100. Reference is also made to the computing device 200. However, the methods herein should not be understood to be limited to the system 100 or the computing device 200, as the methods may be implemented in other systems and/or computing devices. Likewise, the systems and the computing devices herein should not be understood to be limited to the example method 400.

At the outset in the method 400, it should be appreciated that the user 104 is associated with an identity, which is evidenced by multiple different credentials included in the digital wallet 120, including, specifically, for this example, a passport credential, an airplane ticket credential, and a health insurance credential.

As such, when the user 104 arrives at an airport, to depart for a destination, the user 104 is compelled, for example, at boarding, security of otherwise, to provide claims associated with a valid passport, a valid ticket, and health insurance. By way of the present disclosure, the user 104 may rely on the digital wallet 120 and the CCO 122 to provide the claims, together. In connection therewith, the interaction at the airport, with the CCO 122, may be initiated by the user 104 (at the mobile device 102) or by the airport (as the relying party 106), as indicted by the dotted line in FIG. 4.

In particular, the user 104 may initiate the interaction by taping (e.g., via NFC, etc.) or otherwise presenting the mobile device 102 at an airport terminal, which is generally the relying party 106 in this example. In response, the relying party 106 identifies the desired interaction (and the necessary identity claims), and requests, at 402, the above identity claims from the mobile device 102 (specifically, from the CCO 122) for the user 104. The airport terminal may further identify itself to the CCO 122 (e.g., via WIFI, BLE, NFC, etc.). It should be appreciated that the user 104 may instead request the necessary identity claims, via the mobile device 102 and the identity application 110 (e.g., in lieu of a direct interaction with the airport terminal, etc.), in other embodiments (e.g., via an application at the mobile device, etc.). In any case, in connection with the interaction, the user 104 may specifically select the identity claims to share with the airport terminal (e.g., via the digital wallet, etc.). Further, in some embodiments, the user 104 may present a computer-readable indicia (e.g., a QR code, etc.) to the airport terminal, via the mobile device 102, or the user 104 may communicate with the airport terminal via NFC, BLE, etc., to share the identity claims. In other embodiments, the airport terminal may also (or alternatively) provide a computer-readable indicia to the user 104, whereby the user 104 captures the indicia via the mobile device 102 and reads the necessary identity claims therefrom. Moreover, in some embodiments, the airport (as the relying party 106) may initiate the interaction based on pre-provided consent provided by the user 104 to the airport (via an advance interaction, via locally stored preferences within the digital wallet 120, etc.), or via a peer-to-peer connection using a WIFI-hotspot, BLE, etc. (e.g., where the digital wallet 120 or other application is awake in background at the mobile device 102 and is looking for the airport terminal, etc.).

In response, the CCO 122, as part of the mobile device 102, then presents, at 404, the request for the one or more identity claims to the digital wallet 120. The digital wallet 120 then solicits an authentication input from the user 104, at 406. At 408, the user 104 provides the authentication input to the mobile device 102. The authentication input may be consistent, for example, with the authentication attribute included in the digital wallet 120 (as provisioned above in the method 300), or not. In response, the digital wallet 120 authenticates the user 104 based on the authentication input, at 410, and then solicits consent from the user 104, at 412, to share the specific identity claims with the relying party 106. The user 104 provides, at 414, the consent.

In turn, based on the authentication of the user 104 and the consent from the user 104, the digital wallet 120 retrieves the relevant credential for the user 104, mainly, the passport credential, the airplane ticket credential, and the insurance credential, from memory. The digital wallet 120 then compiles, from the different credential, and shares the identity claim(s) to the CCO 122, at 416. Here, the claims may include the relevant information, such as a passport number, airplane ticket detail (e.g., date, time, flight number, seat, etc.), insurance ID number, etc. Upon receipt of the identity claims, the CCO 122, in this example, submits a request for confirmation of the airplane ticket, at 418, to the airline application 118. The airline application 118, in turn, determines if a valid ticket consistent with the request exists (e.g., within the airline application 118 or via a backend associated with the airline application 118, etc.) (generally, a source party 108) and, if valid, confirms, at 420, the airplane ticket with the CCO 122.

The CCO 122, in turn, resolves that all the credentials are specific to the user 104 and further determines, at 424, if the credential(s) are valid based on expiration dates (e.g., valid passport credential when current date is prior to an expiration date of the passport credential, etc.) and/or confirmation from the source parties 108. When the credentials are not valid, the CCO 122 may revoke, at 426, the credentials, for instance, if it is expired or altered based on lack of confirmation from a source party 108.

When the credentials are valid, though, the CCO 122 may impose and/or assess additional controls or policies related to sharing the identity claims (including confirmation) to the relying party 106, etc. In addition, at 428, the CCO 122 generates an assurance level (or assurance score, etc.) for the identity claims being shared. For instance, in the above example, the identity claims may relate to a name of the user 104, a date of birth of the user 104, an image of the user 104, and a residential address of the user 104. In connection therewith, the level of assurance for each of the identity claims may be based on the credentials used in providing the requested information. In particular, the CCO 122 may consult a passport, a driver's license, and a birth certificate for the user's name and date of birth; the passport and the driver's license for the user's image/photo; and the driver's license for the user's residential address. Table 1 illustrates example credentials upon which the assurance level may be generated for the identity claims, and corresponding strength (or value(s)) for each of the credentials (e.g., on a desired scale, based on an indication of superior/strong/fair/weak, etc.).

TABLE 1

| | | Assurance | Assurance |
|---|---|---|---|
| Identity Claim | Credential | Strength | Score |
| Name | Passport | Strong | 5 |
| | Driver's License | Strong | |
| | Birth Certificate | Fair | |
| Date of Birth | Passport | Strong | 5 |
| | Driver's License | Strong | |
| | Birth Certificate | Fair | |
| Photo | Passport | Strong | 4 |
| | Driver's License | Strong | |
| Residential Address | Driver's License | Strong | 2 |

In this example, the identity claims for the name of the user 104 and the date of birth of the user 104 are each associated with three different credentials. Based thereon, the CCO 122 utilizes the strengths of the three credentials (i.e., strong for the passport, strong for the driver's license, and fair for the birth certificate) to define an overall assurance score for each of the identity claims (e.g., as a sum where a strong assurance strength is worth two points and a fair assurance strength is worth one point, etc.) (e.g., 2+2+1=5; etc.). The identity claim for the photo of the user 104 is associated with two different credentials (as the birth certificate doesn't contain a photo). And, the CCO 122 again utilizes a sum of the strengths of the two credentials to define an overall assurance score for the identity claim (e.g., 2+2=4; etc.). Finally, the identity claim for the residential address of the user 104 is associated with one credential (as neither the passport nor birth certificate contain an address). As such, the CCO 122 assigns the assurance score (e.g., 2, etc.) as the value of the one credential (with nothing more added since only one credential is available). Once generated, the individual assurance scores may be shared with the relying party 106 for each of the identity attributers, or an overall assurance score may be generated (based on each of the individuals scores, for example, as a sum, an average, another combination thereof, etc.) and provided to the relying party 106.

The CCO 122 then (and as permitted by policies/controls) shares, at 430, the identity claims (whether including specific details and/or the assurance score, or merely confirmation, or combinations thereof) with the relying party 106, whereby the user 104 is permitted to board the airplane or pass through security. The assurance score, when provided, may be included with the identity claims (as shared with the relying party 106) or apart therefrom.

As can be appreciated, therefore, the CCO 122 in the above description of methods 300 and 400 provides for attributes for multiple credentials to be requested and provided to a relying party, directly or via an application included in the mobile device 102 with the CCO 122.

In view of the above, the systems and methods herein relate to providing verified complex user claims based on multiple credentials included in digital wallets, to relying parties. The complex user claims are based on attributes included in the multiple different credentials, whereby the complex user claims are compiled to inform the relying parties as necessary (regarding identities, etc. of users interacting with the relying parties) but at the same time maintain the other personal identifying information of the credentials secret from the relying parties. In this manner, there is no need for the users to present multiple different physical credentials to the relying parties (to verify their identities), whereby data provided to the relying parties is more efficient because unneeded an unwanted data is not provided to the relying parties.

The systems and methods herein also provide options for verification of individual credentials, by relying parties, based on key pairs associated with issuers of the credentials, whereby assurances of identity claims forwarded to the relying parties may be provided. Moreover, the users' mobile devices, in various embodiments, act independent of source parties (issuing the credentials, etc.) to provide a distributed identity solution. In so doing, the mobile devices may work offline (and apart from identity provider backends associated with the CCO, or potentially with the digital wallet) yet still provide assurances of the complex user claims transmitted to the relying parties. The complex user claims further may be coordinated amongst different applications within the mobile devices (as issuers of credentials for relying parties) to deliver an improved user experience, privacy, security, and convenience, while still accepting a wide variety of credentials (in that the credentials are bound to the mobile devices and the users the presenting the credentials and are cross-referenced through the mobile devices via authentication of the users in a manner consistent with the binding of the credentials to the mobile devices (e.g., through authentication attributes, etc.)).

What's more, the systems and methods herein provide for managing the life cycles of different credentials, whereby users have the ability to hold, arrange, remove, and share identity claims associated with the credentials, while the CCO potentially ensures the validity of the credentials (e.g., that the credentials are not expired, that the credentials are not altered, that the credentials are not cancelled, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one or more of the following operations: (a) receiving a request for identity claims, from a relying party; (b) soliciting an authentication input from the user; (c) authenticating the user based on the authentication input received from the user at the computing device; (d) in response to authentication of the user, compiling from multiple credentials included in the computing device, the identity claims included in the request; (e) sharing the determined identity claims with the relying party, in response to the request; (f) submitting a request for confirmation of a validity of one of the multiple credentials from a source party associated with said one of the multiple credentials; (g) determining a validity of one of the multiple credentials based on an attribute of the one of the multiple credentials; (h) generating, by the computing device, one or more assurance scores for the identity claims; and (i) sharing, by the computing device, the one or more assurance scores with the relying party in response to the request.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing verified complex user claims, based on multiple credentials, to a relying party, the method comprising:
receiving, by a computing device, a request for identity claims, from a relying party, the identity claims including multiple attributes of an identity of a user;
soliciting, by the computing device, an authentication input from the user;
authenticating, by the computing device, the user based on the authentication input received from the user at the computing device;
in response to authentication of the user, compiling, by the computing device, from multiple credentials included in the computing device, the identity claims included in the request; and
sharing, by the computing device, the determined identity claims with the relying party, in response to the request.

2. The computer-implemented method of claim 1, wherein compiling the identity claims includes:
compiling a first one of the identity claims from a first one of the multiple credentials; and
compiling a second one of the identity claims from a second one of the multiple credentials.

3. The computer-implemented method of claim 2, wherein the authentication input includes a biometric input; and
wherein authenticating the user includes comparing the biometric input to an authentication attribute linked to at least one of the multiple credentials.

4. The computer-implemented method of claim 3, wherein the multiple credentials include a passport, a driver's license, an insurance card, and/or a payment card issued to the user; and
wherein the identity claims include at least a name and a government ID number associated with the user.

5. The computer-implemented method of claim 1, further comprising submitting a request for confirmation of a validity of one of the multiple credentials from a source party associated with said one of the multiple credentials; and
wherein sharing the identity claims includes sharing the identity claims only after receipt of the confirmation of the validity of the one of the multiple credentials from the source party.

6. The computer-implemented method of claim 1, further comprising determining a validity of one of the multiple credentials based on an attribute of the one of the multiple credentials; and
wherein sharing the identity claims includes sharing the identity claims only after determining the validity of the one of the multiple credentials.

7. The computer-implemented method of claim 1, wherein the relying party includes an application included in the computing device.

8. The computer-implemented method of claim 7, further comprising:
soliciting, by the computing device, a consent to share the identity claims with the relying party; and
receiving the consent, from the user, at the computing device, to share the identity claims, prior to sharing the identity claims with the relying party.

9. The computer-implemented method of claim 1, further comprising:
generating, by the computing device, one or more assurance scores for the identity claims; and
sharing, by the computing device, the one or more assurance scores with the relying party in response to the request.

10. A non-transitory computer-readable storage medium comprising executable instructions for verifying identity claims, based on multiple credentials, which when executed by at least one processor, cause the at least one processor to:
receive a request for identity claims from a relying party, the identity claims associated with a user;
solicit, at a mobile device of the user, a consent from the user to share the identity claims with the relying party;
solicit, at the mobile device of the user, an authentication input from the user;
authenticate the user based on the authentication input received from the user at the mobile device;
in response to the authentication of the user and the consent received from the user, compile, from multiple credentials included in the mobile device, the identity claims included in the request; and
share the compiled identity claims with the relying party, in response to the request.

11. The non-transitory computer-readable storage medium of claim 10, wherein the executable instructions, when executed by the at least one processor, further cause the at least one processor to:
generate one or more assurance scores for the identity claims; and
share the one or more assurance scores with the relying party in response to the request.

12. The non-transitory computer-readable storage medium of claim 10, wherein the executable instructions, when executed by the at least one processor, further cause the at least one processor to submit a request for confirmation of a validity of one of the multiple credentials from a source party associated with said one of the multiple credentials; and
wherein the executable instructions, when executed by the at least one processor in connection with sharing the identity claims, cause the at least one process or share the identity claims only after receipt of the confirmation of the validity of the one of the multiple credentials from the source party.

13. The non-transitory computer-readable storage medium of claim 10, wherein the executable instructions, when executed by the at least one processor, further cause the at least one processor to determine a validity of one of the multiple credentials based on an attribute of the one of the multiple credentials; and
wherein the executable instructions, when executed by the at least one processor in connection with sharing the identity claims, cause the at least one process or share the identity claims only after determining the validity of the one of the multiple credentials.

14. The non-transitory computer-readable storage medium of claim 10, wherein the executable instructions, when executed by the at least one processor in connection with compiling the identity claims, cause the at least one processor to:
compile a first one of the identity claims from a first one of the multiple credentials; and
compile a second one of the identity claims from a second one of the multiple credentials.

15. The non-transitory computer-readable storage medium of claim 14, wherein the authentication input includes a biometric input; and
wherein the executable instructions, when executed by the at least one processor in connection with authenticating the user, cause the at least one processor to compare the biometric input to an authentication attribute linked to at least one of the multiple credentials.

16. The non-transitory computer-readable storage medium of claim 15, wherein the multiple credentials include a passport, a driver's license, an insurance card, and/or a payment card issued to the user; and
wherein the identity claims include at least a name and a government ID number associated with the user.

17. The non-transitory computer-readable storage medium of claim 10, wherein the executable instructions, when executed by the at least one processor, further cause the at least one processor to:
solicit a consent to share the identity claims with the relying party; and
receive the consent, from the user, at the mobile device, to share the identity claims, prior to sharing the identity claims with the relying party.

18. A system for use in providing verified claims, based on multiple credentials, to a relying party, the system comprising a computing device including a complex claims orchestrator (CCO) and a digital wallet;
wherein the CCO is configured to:
receive a request for identity claims from a relying party; and
communicate the request to the digital wallet;
wherein the digital wallet is configured to:
solicit an authentication input from the user;
authenticate the user based on the authentication input received from the user at the computing device;
in response to authentication of the user, compile from multiple credentials included in the computing device, the identity claims included in the request; and
share the determined identity claims with the CCO; and
wherein the CCO is configured to share the determined identity claims, received from the digital wallet, with the relying party in response to the request.

19. The system of claim 18, wherein the CCO is further configured to:
generate one or more assurance scores for the identity claims; and
share the one or more assurance scores with the relying party in response to the request.

20. The system of claim 18, wherein the CCO is further configured to determine a validity of at least one of the multiple credentials; and
share the determined identity claims with the relying party only after a determination that the at least one of the multiple credentials is valid.
